(19) United States
(12) Patent Application Publication
(10) Pub. No.: US 2023/0108009 A1
(43) Pub. Date: Apr. 6, 2023

(54) Tire Rim Shield

(71) Applicant: Joe Smith, JR., Lillington, NC (US)

(72) Inventor: Joe Smith, JR., Lillington, NC (US)

(21) Appl. No.: 17/718,947

(22) Filed: Apr. 12, 2022

Related U.S. Application Data
(60) Provisional application No. 63/252,783, filed on Oct. 6, 2021.

(51) Int. Cl. B05B 12/34

(52) U.S. Cl. CPC B05B 12/34

(57) ABSTRACT

The present invention relates to a rim or hub shield for protecting a rim of a tire from harmful tire cleaning solutions. The rim shield features a round body having a slightly concave contour, an exterior surface and a concave interior surface, and a pair of oval cut-outs around the center of the shield allowing a user to grip the device. The shield includes a pair of pockets for storing cleaning supplies and other accessories. The shield can be placed against the rim using one hand while cleaning can be performed using the other hand. Alternatively, the shield can be securely placed around the rim by securing a protrusion along the periphery of the shield around the rim of the tire.

### CROSS-REFERENCE TO RELATED APPLICATION

The present application claims priority to, and the benefit of, U.S. Provisional Application No. 63/252,783, which was filed on Oct. 6, 2021, and is incorporated herein by reference in its entirety.

### FIELD OF THE INVENTION

The present invention relates generally to vehicular care accessories. More specifically, the present invention relates to a novel tire rim shield device for vehicles. The shield device is configured to cover a rim or hubcap of a tire for protecting the rim or hubcap from corrosive chemicals and sprays used in cleaning a tire, wheel well, or the surrounding body of the vehicle. The rim has a pair of oval cut-outs disposed centrally for holding the cover or shield in position and has a pair of pockets or indentations for storing cleaning or other accessories such as a cell phone. The shield or cover can be used with any commercial and personal vehicle and is designed as an inexpensive, reusable and compact device. Accordingly, the present disclosure makes specific reference thereto. Nonetheless, it is to be appreciated that aspects of the present invention are also equally applicable to other like applications, devices and methods of manufacture.

### BACKGROUND

By way of background, cleaning and detailing tires of vehicles, such as cars, motorcycles, trikes, trucks and other customized transportation, is a common process to maintain the cleanliness of tires and increase the appeal of the vehicle. Detailing also increases life of the tires as it prevents cracking of the tires due to use and exposure to the elements. Generally, for performing cleaning and detailing, corrosive sprays, polishing and other cleansing and restoration chemicals are sprayed or otherwise applied on the tires in addition to using conventional soap and other cleaning solutions. Often, people spray the tire including the rim, wheel well, vehicle frame; and sometimes, even with precise spray only on the tire, the rims are accidentally or inadvertently sprayed. Accordingly, users cleaning the tires need to spend additional time in wiping off the sprayed rims and restoring the rims to their original luster. People desire an invention that can prevent the rims and hubcaps from being damaged during the tire cleaning process.

Generally, the tire cleaning solutions are corrosive and may cause damage, stain the rims or have other deleterious effects on the chrome plating. Over prolonged exposure, the cleaning solution can ruin the rims and hubs. While cleaning the tires, if users do not quickly remove the overspray from the rims or hub, the rims or hubs may be stained permanently detracting from the value of the vehicle and potentially requiring the owner to have to replace the rims or hubs, which can be a costly undertaking. Accordingly, people desire a device that can protect the rims from corrosive chemicals.

Conventional ways of protecting the rims and wheel hubs include the practice of using a paper or a piece of cloth to cover the rim, however, such methods are ineffective but also require a user to hold the paper or cloth which drastically affects the efficiency and quality of the cleaning process of tires. In addition, the use of paper shields leads to waste and cloth shields require washing to be used again.

A common problem faced by vehicle owners is that, when engaging in activities such as cleaning tires and the vehicles, they forget one or another cleaning accessory such as sponge, cleaning, polishing solution and other items. In addition, since cleaning a vehicle and the tires usually requires both hands, it would be helpful to have a cleaning accessory that the vehicle owner could use to hold other items such as a cell phone. Users end up spending a lot of time searching for the cleaning accessories. It would be helpful if the vehicle owner had a storage mechanism that can easily hold their lightweight cleaning and detailing accessories for easy access.

Therefore, there exists a long-felt need in the art for a tire rim or hub shield device that protects a vehicle's rims or hubs from exposure to abrasive and other chemicals when cleaning tires. There is also a long-felt need in the art for a rim or hub shielding device that can be easily placed over a rim while cleaning the tires. Additionally, there is a long-felt need in the art for a rim or tire hub shield device that does not affect the process of cleaning tires using any kind of spray. Moreover, there is a long-felt need in the art for a rim or tire hub protecting device that provides for convenient storage of cleaning accessories for cleaning and detailing tires. Further, there is a long-felt need in the art for a vehicle rim or hub protective device that eliminates the need to wipe off stains and overspray on the rim due to spraying of chemicals, polishes, and other corrosive sprays. Finally, there is a long-felt need in the art for a user-friendly device that will aid car owners and detailers in yielding a more professional, sharp appearance for their vehicles without affecting appearance of rims or tire hubs.

The subject matter disclosed and claimed herein, in one embodiment thereof, comprises a rim shield or hub cover device for protecting a rim or tire hub of a tire from being sprayed while cleaning off the tire. The rim shield or tire hub device can be manufactured in a variety of sizes and colors and is configured to cover rims and tire hubs of all commercial and personal vehicles. The rim shield or tire hub has a generally round-shaped concave body having an exterior surface and an interior surface and a pair of oval cut-outs positioned around the center of the body. The pair of oval cut-outs are used for receiving fingers and thumbs of a user for gripping the device. At least one pocket and preferably first and second offset of pockets positioned on either side of the oval cut-outs. The pair of pockets have an opening for receiving at least tire cleaning or other accessories, such as a cell or mobile phone. The invention is dimensioned to cover the rim or hub and absorb the chemical being sprayed thereon while cleaning the tire or hub. The device can be placed against the rim with one hand and cleaning of the tire can be performed with other hand. Alternatively, the device can be secured around the periphery of the rim or hub allowing a user to perform cleaning operation using both hands.

In additional embodiment, the shield or cover has an outer periphery which may include a flexible seal that can be pressed against the tire in order to help seal the shield against the tire to prevent chemicals or other solution from seeping in around the exterior of the cover. In a still further embodiment, an expansible or accordion configuration is provided on the periphery of the cover or shield to allow a cover to be expanded to cover or protect different sized tires. The outer edge of the accordion configuration may also be provided with a flexible or rubber sealing element to form a seal between the cover and the tire.

In a still further embodiment, a rim cover and tire combination are disclosed and include a tire having a rim enclosed by the tire, and having a groove separating the rim from the tire. A rim cover sized and configured to fully cover the rim and the rim cover having a periphery to fit within the groove and hold the cover in position over the rim. Hand holds and pockets are provided in the cover to help hold the cover to the rim and to hold accessories of the user of the rim cover.

In this manner, the rim or hub shield device of the present invention accomplishes all of the forgoing objectives and provides users with a round or circular protective shield made of inexpensive material such as corrugated cardboard or plastic for covering a rim or hub while cleaning off tires using corrosive, polishing or cleaning sprays. The device can be designed for use with any personal and commercial vehicle and helps in a more professional and sharp appearance on their vehicles. The device is easy to install, remove and use while providing space for storing cleaning solutions, accessories and other personal items.

### SUMMARY OF THE INVENTION

The following presents a simplified summary in order to provide a basic understanding of some aspects of the disclosed innovation. This summary is not an extensive overview, and it is not intended to identify key or critical elements or to delineate the scope thereof. Its sole purpose is to present some general concepts in a simplified form as a prelude to the more detailed description that is presented later.

The subject matter disclosed and claimed herein, in one embodiment thereof, comprises a rim or cover shield device for protecting a rim or hub of a tire. The rim or hub shield device has a generally circular shaped concave body having an exterior surface and an interior surface which is the interior concave area while the exterior surface bows out forming the opposite shaped surface. A pair of oval cut-outs are positioned around the center of the body. The pair of oval cut-outs are used for receiving fingers and thumb of a user for grasping and handling the device. The at least one pocket or multiple pockets are positioned on either side of the oval cut-outs which may be at the 3 and 6 o'clock positions, 12 and 6 o'clock positions or other preferable configurations. The pockets have an opening each for receiving a tire cleaning accessory or other item such as a mobile phone. The device is dimensioned to cover the rim, hub and absorb the chemical or other solution being sprayed thereon while cleaning the tire.

In yet another embodiment, the rim or hub shield has a protrusion running along the circular periphery of the device and extending away from the interior surface such that the protrusion is secured around the rim. The edge of the periphery may also have an expansible rubberized ring to form a seal between the shield and the tire surface. In addition, an accordion like structure may be expanded to cover different sizes of tires.

In yet another embodiment, the rim shield device is placed against the rim by gripping the device using one hand and cleaning of the tire is performed using the other hand.

In yet another embodiment, the rim shield device is made from corrugated cardboard or other inexpensive material such as plastic, recycled plastic, and post-consumer waste materials. In addition, the shield or cover may include marketing or other indicia which can be used as a promotional give away by tire manufacturers and other merchandisers.

In yet another embodiment, the rim shield device has 300 GSM to 600 GSM, and the the rim shield device is flexible and has a one-piece structure.

In yet another embodiment, the rim shield device has a diameter in the range 16″-24″ for accommodating rims of personal vehicles and commercial vehicles.

In yet another embodiment, a method for protecting a rim or hub while cleaning a tire using sprays, solutions and other chemicals is disclosed. The method includes the steps of providing a rim shield device, with the shield device having a generally round configuration and substantially or completely covers the rim. The rim has a pair of cut-out handles or hand holds and at least one pocket and in another embodiment a pair of or first and second pockets. Next, the shield device is positioned on or over the rim and holding the shield device in position against the rim or hub by grasping the device via the cut-out handles or hand holds using one hand. Then spraying the cleaning solution on the tire with the other hand, and removing the shield device once the spraying and other cleaning processes are complete.

In yet another embodiment, a method for protecting a rim or hub of a tire while they are being cleaned is disclosed. The method includes the initial step of providing a rim shield device that is generally round and that covers the rim and secures around the periphery of the rim or hub. The rim shield device comprises a pair of cut-out handles or hand holds and at least one pocket, and preferably first and second pockets. Next, the rim shield device is positioned on the rim or hub and secured to the rim's periphery. Next, cleaning or other accessories are stored in the pockets, and a cleaning solution can be safely applied to the tire without damaging the rim. Finally, the shield of rim cover device may be removed once the spraying and other cleaning processes are complete.

In yet another embodiment, a rim shield device is disclosed. The rim shield is made from an inexpensive material such as a corrugated cardboard, recycled plastic, post-consumer waste material or other recyclable plastics or cellulosic materials and includes two strategically placed oval cut-outs used for gripping, and a pair of shallow, collapsible pockets positioned on the exterior surface of the shield or rim and generally on either side of the cut-outs, such as the 3 or 9 o'clock position, 12 and 6 o'clock position or other configuration. The rim shield is held in one hand against the rim while performing cleaning of the tire with the other hand.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar referenced characters refer to similar parts throughout the different views, and in which:

FIG. 1 illustrates a perspective view of one potential embodiment of the vehicle rim shield device of the present invention in accordance with the disclosed architecture;

FIG. 2A illustrates a rear perspective view of one potential embodiment of the rim shield device of the present invention in accordance with the disclosed architecture;

FIG. 2B illustrates a cut away of the periphery of one potential embodiment of the tire shield device of the present invention and showing an accordion configuration and a flexible shield in accordance with the disclosed architecture;

FIG. 3 illustrates a perspective view of one potential embodiment of the shield device of the present invention being handled and gripped by a user in accordance with the disclosed architecture;

FIG. 4 illustrates an in-use perspective view of one potential embodiment of the vehicle rim shield device of the present invention in accordance with the disclosed architecture; and

FIG. 5 illustrates a close-up view of one potential embodiment of the rim shield or hub device of the present invention secured on the rim of a tire in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a tire rim or hub shield device that protects a vehicle's rims or hubs from exposure to abrasive chemicals and other solutions when cleaning tires. There is also a long-felt need in the art for a rim or hub shielding device that can be easily deployed over a rim or hub while cleaning tires or other portions of the vehicle frame where the cleaning solutions may come into contact with the hub or rim. Additionally, there is a long-felt need in the art for a rim or hub shield or protective device that does not affect the process of cleaning the tires, wheel wells or vehicle body. Moreover, there is a long-felt need in the art for a rim or hub protecting device that provides for the storage of cleaning or other accessories for the cleaning and detailing of tires. Further, there is a long-felt need in the art for an easily useable vehicle rims or hubs protective device that eliminates the requirement of having to wipe off stains or other material on the rim or hub which was caused due to application of cleaning materials to the tires, wheel wells or surrounding frame areas. Finally, there is a long-felt need in the art for a user-friendly device that will aid car owners and detailers in yielding a more professional, sharp appearance on their vehicles without affecting appearance of rims.

The present invention, in one exemplary embodiment, is a novel rim or hub shield for protecting rims and hubs from the overspray or application of harmful and corrosive tire cleaning solutions to the tire or surrounding areas. The rim shield is made from corrugated cardboard or other inexpensive material such as plastic, recycled plastics, post-consumer waste materials or other combinations of material and includes at least one and preferably two strategically-placed oval cut-outs used for gripping and holding the shield in position. At least one, and in other embodiments, first and second shallow and collapsible pockets are positioned at different areas on the exterior face of the shield such as at the 9 and 3 o'clock position, the 6 and 12 o'clock position or other suitable configurations on either side of the cut-outs for storing cleaning and other accessories, the rim and hub shield is held in one hand against the rim while performing cleaning with the other hand. In other embodiments, the periphery may have a flexible edge so as to form a seal between the shield and the rim. In a further embodiment, the periphery may have an expansible portion to allow the operator to expand the perimeter to cover different sized tires.

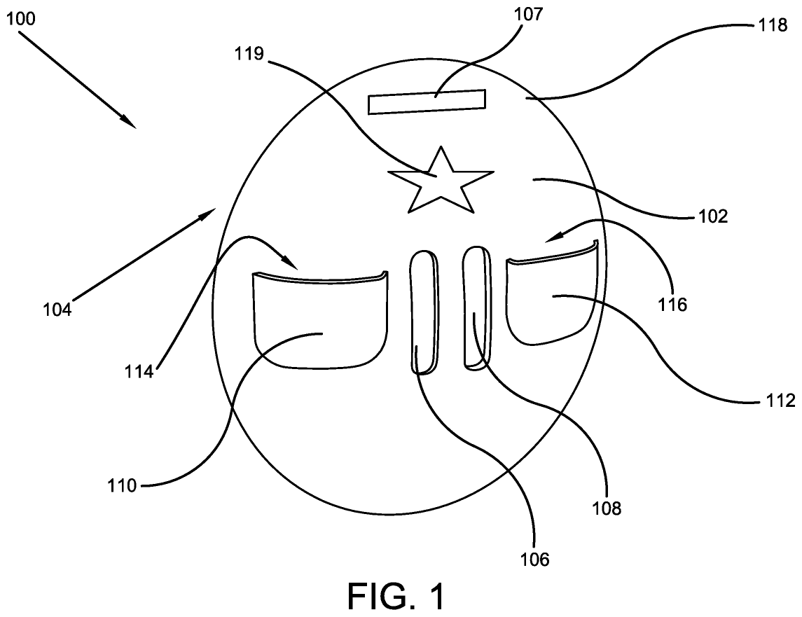

Referring initially to the drawings, FIG. 1 illustrates a perspective view of one potential embodiment of the vehicle rim or hub shield or protective cover of the present invention in accordance with the disclosed specification. The vehicle rim or hub shield or protective cover 100 of the present invention is designed as a round protective shield made of corrugated cardboard or other inexpensive material which may have absorbent or wicking properties to pull fluids away from the hub or rims and is configured to protect and preserve rims of vehicles by shielding them against harmful cleaning chemicals and other solutions. More specifically, the shield device 100 is used by professionals and vehicle owners for covering and protecting rims from harmful and corrosive chemicals and sprays while cleaning and detailing vehicles, tires and surrounding areas. The cover has a thickness ranging from 1/32″ to about 1 inch and a density of about 30-90 km/m3.

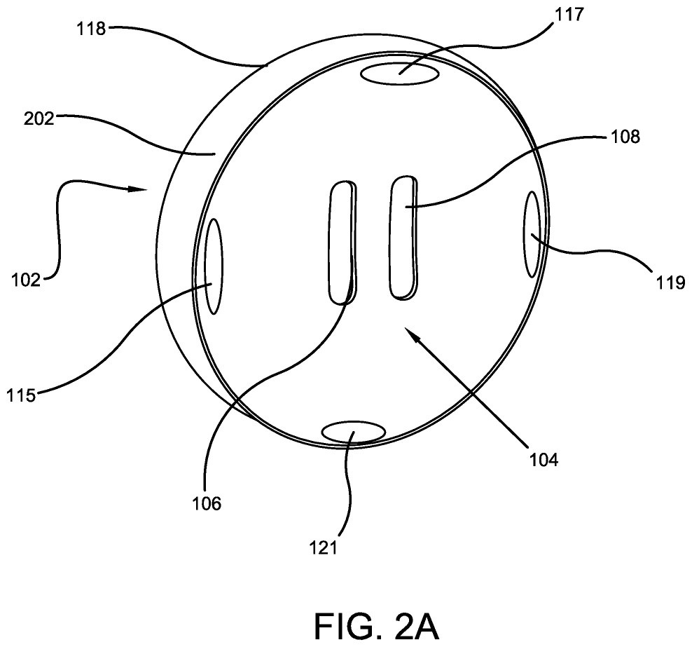

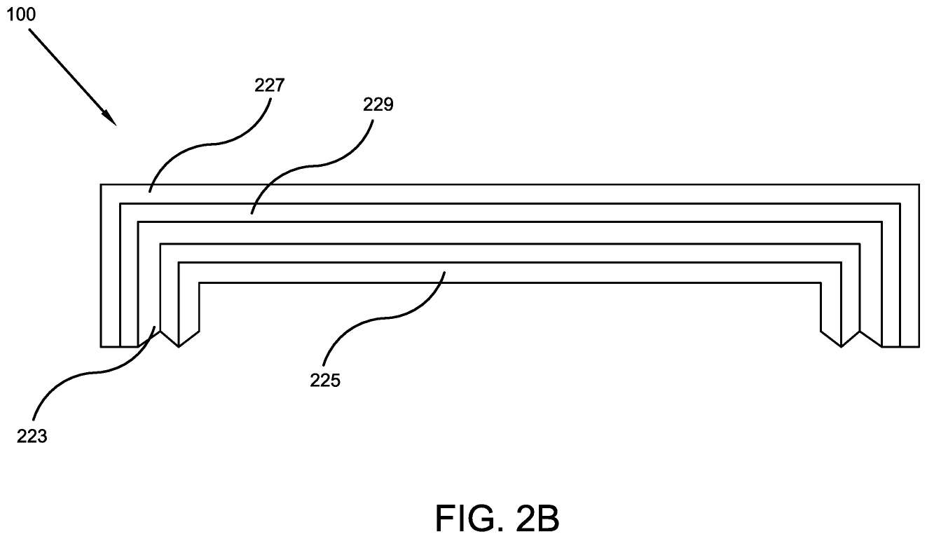

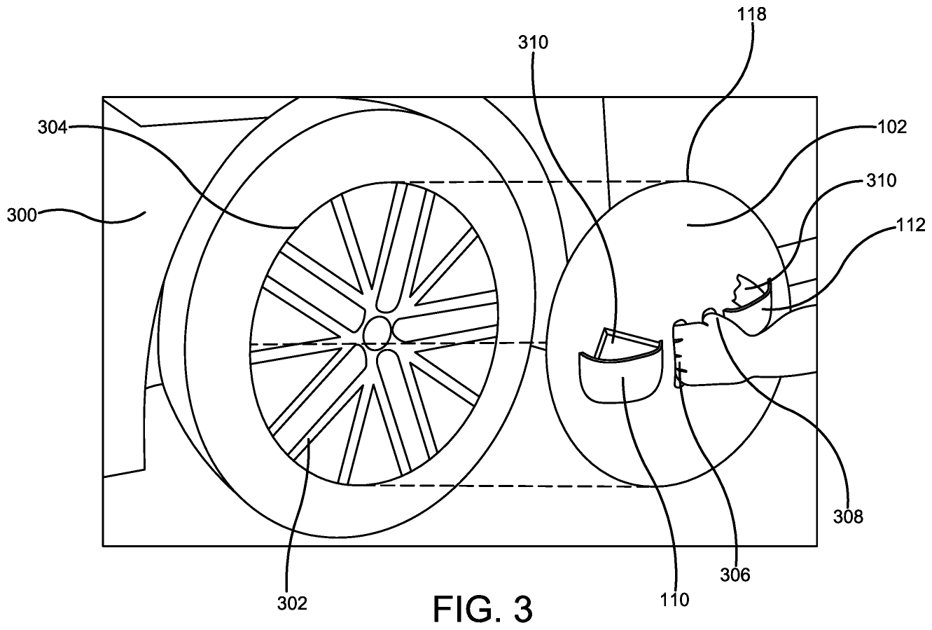

The rim or hub shield device 100 is a circular and slightly concave shield having an exterior surface 102 curving outwardly and an interior surface 104 curving inwardly. The device 100 is dimensioned having rim or hub sizes of conventional vehicles and can be customized to fit rims of all international vehicles. The interior surface 104 is slightly concave inwardly, therefore, allowing the shield device 100 to easily fit around the periphery of a rim or hub. The circular edge 118 of the device 100 fits in a groove positioned between the tire and the rim of a vehicle allowing the device 100 to securely cover the rim while the tire of the vehicle is sprayed with a cleaning solution. The circular edge 118 or periphery may have a flexible ring 227 (see FIG. 2A) so that the edge creates a seal with the tire and prevents the cleaning solution from seeping in around the edge. The exterior surface 102 faces away from the rim (and is visually exposed to a user and extends outwardly) when the shield device 100 is positioned on a rim or hub. The shield device 100 has at least one, and in one embodiment, first and second of vertical oval cut-outs 106, 108 positioned around the center of the device 100. The cut-outs or hand holds 106, 108 are about 4″-5″ in length and are positioned 1″-2″ apart to allow easy holding of the shield and are configured to function as a handle for gripping the device 100 by a user as illustrated in FIG. 3. The hand holds 106, 108 and 107 extend from the exterior surface to the interior surface and through the thickness of the cover. In alternative embodiments, a hand hold 107 may be positioned near the top of the shield 100 so that the user can hold the shield at the top of the tire while cleaning the lower portion of the tire.

The exterior surface 102 has at least one pocket and in one embodiment has first and second pockets 110, 112 positioned thereon and preferably on either side of the handles 106, 108 or below the handle 107. The pockets 110, 112 are used for accommodating cleaning supplies such as sponges, clothes and other accessories. The left pocket 110 has a top opening 114 and is sewn, fused, adhered or closed from the sides and bottom forming a pocket. Similarly, the right pocket 112 has a top opening 116 and is sewn or closed from the sides and bottom. The pockets 110, 112 have a length of about 3″-4″ and has a width of about 3″-4″, thereby providing an adequate space for storing conventional cleaning supplies required by a user for performing cleaning of a vehicle and other accessories such as protective glasses, sunglasses, cell phones or other items. The protective cover 100 may also be provided with graphics, indicia, or other marketing information 119 which can be used as part of a promotional offering by cleaning solutions company, tire companies or other companies which may benefit from marketing the tire cover of the present invention.

The shield device 100 is preferably made of a soft, lightweight, and flexible material like a corrugated cardboard, plastic, recycled plastics, post-consumer waste or combinations thereof. The shield device 100 may be absorbent and absorbs any spray accidentally sprayed thereon and therefore eliminates chemical being dripped from the shield device 100 onto the hub or rim. Further, the device 100 is easy to carry and store and can be used by both professional and novice users while cleaning vehicles and especially during spraying tires with chemicals and other cleaning solutions.

FIG. 2A illustrates a rear perspective view of the rim shield 100 of the present invention in accordance with the disclosed specification. The interior surface 104 is slightly concave inwardly allowing the protective cover 100 to easily cover and protect a rim or hub of a vehicle. More specifically, the device 100 has a thin protrusion 202 along the periphery 118. The protrusion 202 runs along the periphery 118 and extends from the interior surface 104. The protrusion 202 is secured and positioned along the rim for covering the rim by the device 100. The periphery may have a flexible ring attached to the periphery in order to create a seal on the hub and tire. The flexible ring may be made from silicone, rubber, urethane foam or other inexpensive material. The device 100 can be pulled easily by gripping the device 100 using the handles 106, 108 thereby releasing the protrusion 202. The interior surface 104 may be provided with one or more magnets 115, 117, 119 and 121 positioned around the periphery of the surface to aid in magnetically holding the cover to the rim or hub of the tire. Suitable magnets include neodymium, alnico and samarium magnets with neodymium being preferred.

In alternative embodiment, the shield device 100 can come without the protrusion 202. Accordingly, the shield or cover 100 is held against the rim of a tire using one hand of the user and cleaning of the tire is performed using the other hand. This is useful in cases where spraying or cleaning is performed on the tire.

FIG. 2B shows a cut away of a portion of the protective cover 100 showing the outer cover 225 having a periphery 229 and outer sealing edge 227. The cover 225 has an accordion or expansible portion 223 which allows the periphery to expand to cover tires of different sizes and diameters.

FIG. 3 illustrates a perspective view showing the shield device 100 being handled and gripped by a user in accordance with the disclosed specification. As illustrated, the rim shield or protective cover 100 is dimensioned according to the rim or hub 302 size of the vehicle 300 and more specifically, the peripheral edge 118 and the protrusion 202 (shown in FIG.2) covers the periphery 304 of the rim 302. A user inserts at least one finger 306 in an oval cut-out 106 and inserts thumb 308 in the other oval cut-out 108 for easily handling the device 100 and further, the cleaning and other supplies 310 are stored in the pockets 110, 112 for easy access during a cleaning process.

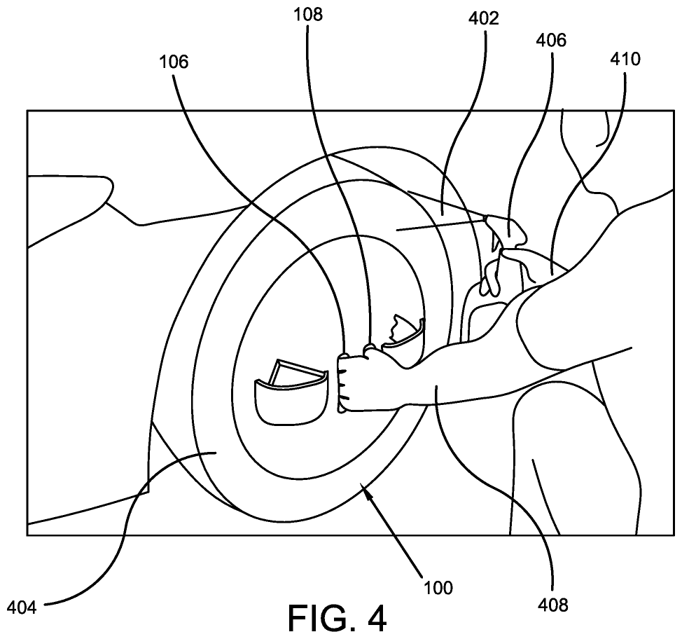

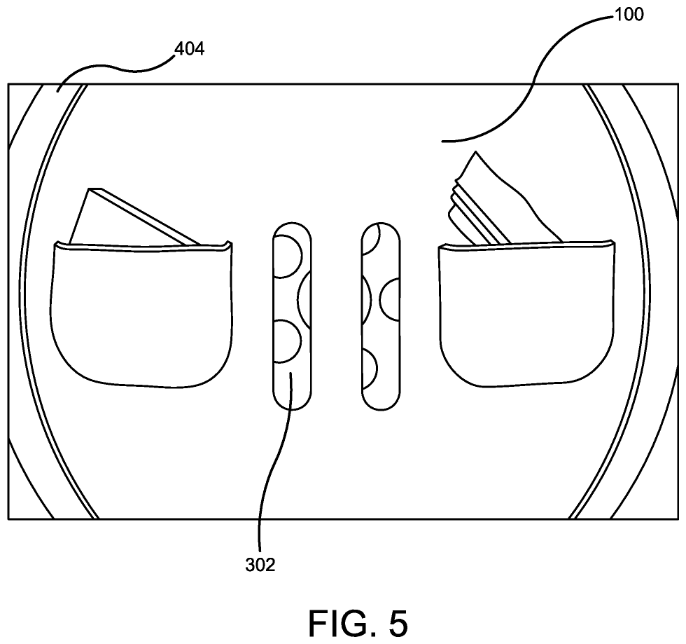

FIGS. 4-5 illustrate in-use perspective views of the vehicle rim shield or protective cover 100 of the present invention in accordance with the disclosed specification. As illustrated in FIG. 4, for protecting rim or cover of the tire 404 from accidental chemical spills while spraying or cleaning the tire with corrosive or other chemicals 402 on tire 404 from a sprayer or applicator 406. The rim shield or protective cover 100 is positioned and secured against the rim of the tire 404 by one hand 408 of the user. The shield 100 does not cover any portion of the tire 404 and therefore does not affect the cleaning and detailing process of the tire. Further, the shield or cover 100 is securely placed onto the rim or hub and therefore allows a user to use the other hand 410 for the cleaning process and spraying cleaning material.

When a user wishes to place the shield or cover 100 to the rim 302, the user grabs the cover 100 using the handles or hand holds 106, 108 or in other embodiments 107, and positions on the rim 302 on the tire. Then the user can perform the cleaning process without requiring spending additional energy and resources cleaning off accidental overspray, chemical spills or leakage from the tire.

FIG. 5 illustrates a close-up view of the rim shield or cover 100 secured on the rim of a tire in accordance with the disclosed description. In the present embodiment, the shield or cover 100 is secured around the rim by securing the protrusion 202 around the rim 302. The flexible seal 227 (see FIG. 2B) then seals the area between the periphery of the cover 100 and the hub. The periphery of the shield 100 may be extended by the expandable portion 223 (see FIG. 2B) to cover different dimensions of tires. Therefore, when the user is finished hooking the shield device 100 onto the rim 302, the user can perform the cleaning process using both hands and without requiring spending additional energy and resources cleaning off accidental chemical spills, overspray or leakage from the rim. The rim shield device 100 absorbs the accidental spills and can be removed by pulling the device 100 from the rim 302.

The rim shield device 100 of various embodiments of the present invention includes a variety of colors, sizes, and designs and can be used at home, garages, and service areas of vehicles. Any conventional manufacturing and printing techniques can be implemented to manufacture the rim shield device. The rim shield device 100 eliminates the requirement to spend additional energy and resources cleaning off accidental chemical spills, overspray, or spreads from the rims and aid car owners and detailers in yielding a more professional and sharp appearance on their vehicles. Installation and removal of the shield device 100 is extremely easy and does not require any mechanical fasteners. Further, no changes or modifications are required in the rim, hub or the tire for using the shield or protection cover 100 of the present invention.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “rim shield device”, “shield device”, “device”, “vehicle rim shield device” and “tire rim shield device” are interchangeable and refer to the vehicle rim shield device 100 of the present invention.

Notwithstanding the forgoing, the vehicle rim shield device 100 of the present invention can be of any suitable size and configuration as is known in the art without affecting the overall concept of the invention, provided that it accomplishes the above-stated objectives. One of ordinary skill in the art will appreciate that the vehicle rim shield device 100 as shown in the FIGS. are for illustrative purposes only, and that many other sizes and shapes of the vehicle rim shield device 100 are well within the scope of the present disclosure. Although the dimensions of the vehicle rim shield device 100 are important design parameters for user convenience, the vehicle rim shield device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A protective cover for a wheel rim, the protective cover comprising:
a cover having an exterior surface, an interior surface and a periphery, wherein the cover is comprised of a concave shape with the interior surface shaped inwardly and the exterior surface shaped outwardly;
a hand hold disposed on the cover; and
at least one pocket formed on the exterior surface of the cover, wherein the at least one pocket is sized and configured to hold an accessory.

2. The protective cover as recited in claim 1, wherein the periphery comprises a seal extending around the periphery.

3. The protective cover as recited in claim 1 further comprising a second hand hold.

4. The protective cover as recited in claim 3, wherein each of the first hand hold and the second hand hold has a length of between 4 and 5 inches, and are spaced apart by a distance that is between 1 and 2 inches.

5. The protective cover as recited in claim 1 comprising a first pocket and a second pocket.

6. The protective cover as recited in claim 5, wherein each of the first and second pockets is disposed at either a 3 o'clock and 9 o'clock orientation or a 6 o'clock and 12 o'clock orientation.

7. The protective cover as recited in claim 5, wherein each of the first and second pockets has a length of between 3 and 4 inches, and a width of between 3 and 4 inches.

8. The protective cover as recited in claim 1, wherein the periphery comprises an expansible edge portion.

9. The protective cover as recited in claim 1, wherein the interior surface is comprised of at least one magnet for magnetically holding the cover to a wheel hub or the wheel rim.

10. The protective cover as recited in claim 1, wherein the cover is comprised of a select one of a corrugated cardboard, a plastic, a recycled plastic or a post-consumer waste material.

11. The protective cover as recited in claim 2, wherein the flexible seal is comprised of a select one of a silicone, a rubber or a polyurethane foam.

12. A rim shield comprising:
a concave cover having an interior surface, an exterior surface and a periphery that is sized and configured to fit within a groove between a tire and a rim, wherein the concave cover has a thickness ranging from about 1/32 of an inch to about 1 inch;
a first hand hold;
a second hand hold, wherein each of the first and second hand holds extend through the concave cover from the exterior surface to the interior surface;
a first pocket on the exterior surface; and
a second pocket on the exterior surface, wherein each of the first and second pockets are disposed away from the first and second hand holds.

13. The rim shield as recited in claim 12, wherein the periphery comprises a flexible seal made from one of a silicone, a rubber or a polyurethane foam.

14. The rim shield as recited in claim 12, wherein each of the first and second pockets have a length that is between 3 and 4 inches and a width that is between 3 and 4 inches, inclusive.

15. The rim shield as recited in claim 12, wherein the concave cover is comprised of an absorbent material.

16. The rim shield as recited in claim 12, wherein each of the first and second hand holds have a length of between 4 and 5 inches inclusive, and are spaced about 1 to 2 inches apart from one another.

17. The rim shield as recited in claim 12, wherein the first pocket is disposed on one side of the first and second hand holds and the second pocket is disposed on another side of the first and second hand holds.

18. The rim shield as recited in claim 17, wherein each of the first and second pockets is disposed at either a 3 o'clock and 9 o'clock orientation or a 6 o'clock and 12 o'clock orientation.

19. A rim cover and tire combination comprising:
a tire having a rim enclosed by the tire, and a groove separating the rim from the tire;
a rim cover sized and configured to fully cover the rim, wherein the rim cover comprises a periphery to fit within the groove and hold the rim cover in position over the rim;
at least one hand hold positioned on the rim cover to help hold the rim cover to the rim; and
at least one pocket positioned on the rim cover to hold an accessory of the user, wherein the rim cover further comprises a concave shape, an interior surface and an exterior surface, and further wherein the at least one hand hold extends through the rim cover from the exterior surface to the interior surface.

20. The rim cover and tire combination as recited in claim 19 further comprising a second hand hold and a second pocket.
